(19) United States
(12) Patent Application Publication
(10) Pub. No.: US 2015/0095355 A1
(43) Pub. Date: Apr. 2, 2015

(54) SYSTEMS AND METHODS FOR DYNAMIC EVENT CONTENT CURATION

(71) Applicant: Banjo, Inc., Redwood City, CA (US)

(72) Inventor: Damien Patton, Redwood City, CA (US)

(21) Appl. No.: 14/501,436

(22) Filed: Sep. 30, 2014

Related U.S. Application Data
(63) Continuation-in-part of application No. 14/043,479, filed on Oct. 1, 2013.
(60) Provisional application No. 61/885,322, filed on Oct. 1, 2013.
(60) Provisional application No. 61/918,126, filed on Dec. 19, 2013.
(60) Provisional application No. 62/006,632, filed on Jun. 2, 2014.

(51) Int. Cl. G06F 17/30; H04W 4/02

(52) U.S. Cl. CPC G06F 17/30241; H04W 4/021
USPC 707/754; 707/736

(57) ABSTRACT

A method for dynamically curating content based on geographic location, including: concurrently monitoring content tagged with geographic locations located within a plurality of predetermined geofences, each geofence comprising a set of linear boundaries forming a closed loop encircling a geographic region; selecting a geofence from the plurality of geofences in response to a content generation parameter for content associated with the geofence exceeding a threshold parameter value; aggregating content associated with the geofence into a content feed; and sending the content feed to a first user device.

### CROSS-REFERENCE TO RELATED APPLICATIONS

This application is a continuation in part of U.S. patent application Ser. No. 14/043,479 filed 1 Oct. 2013, and claims the benefit of U.S. Provisional Application Nos. 61/885,322 filed 1 Oct. 2013, 61/918,126 filed 19 Dec. 2013, and 62006632 filed 2 Jun. 2014, which are incorporated in their entireties by this reference.

This application is related to U.S. patent application Ser. No. 13/678,404 filed 15 Nov. 2012, which is incorporated in its entirety by this reference.

### TECHNICAL FIELD

This invention relates generally to the content curation field, and more specifically to a new and useful system and method for content curation leveraging dynamic geofencing in the content curation field.

### BACKGROUND

The increased popularity of social networking systems has resulted in a plethora of content created in relation to various events. However, most of the content generated about a given event is irrelevant to the general user population. The inventors have discovered that the most event-relevant content is the content generated at the event location. More specifically, the inventors have discovered that the most relevant content is the content generated within the bounds of an event location, and that the content generated outside of those boundaries is not only irrelevant, but dilutes the content of interest to a user. The inventors have additionally discovered that the shapes of the event boundaries are critical to relevant content curation as well.

Conventional systems and methods fail to address this issue. Conventional content curation systems leverage content geofencing, but the geofence is typically a radius about a given location. Conventional systems fail to create or use tailored event boundaries for content curation of each event. Furthermore, conventional systems do not permit users to create their own unique or specific event region by which content is curated.

Thus, there is a need in the content curation field to create a new and useful system and method of event boundary definition for content curation.

### BRIEF DESCRIPTION OF THE FIGURES

FIG. 1 is a flow diagram of the method of dynamic content curation.

FIG. 2 is a flow diagram of a variation of the method.

FIG. 3 is a schematic representation of a variation of the method including monitoring multiple geofences to identify an event in any of the monitored geofences, and adjusting the event boundary geofence in response to receipt of a boundary adjustment input.

FIG. 4 is a schematic representation of a variation of the method including detecting an event based on a pattern of content clustering, and identifying a geofence that encompasses the event-associated content as the event boundary.

FIG. 5 is a schematic representation of a variation of the method including concurrently monitoring a plurality of geofences, aggregating the content associated with each geofence into a content feed, and analyzing the aggregated content for each geofence to detect the occurrence of an event, and sending the content feed for the geofence associated with the event to user devices.

FIG. 6 is a schematic representation of an example variation of the method including receiving a region identifier from a user, determining a geofence based on the region identifier, and aggregating content associated with (e.g., geotagged with a location within) the geofence into a content feed.

FIG. 7 is an example of receiving an event timeframe selection from a user.

FIG. 8 is an example of adjusting the geofence in response to receipt of a new boundary selection from a user.

FIG. 9 is an example of adjusting the geofence based on the geotagged locations of content generated by a tracked user.

FIG. 10 is an example of adjusting the geofence in response to content inclusion into the content feed.

FIG. 11 is an example of adjusting the geofence in response to content exclusion from the content feed.

FIGS. 12, 13, and 14 are examples or defining geofences.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

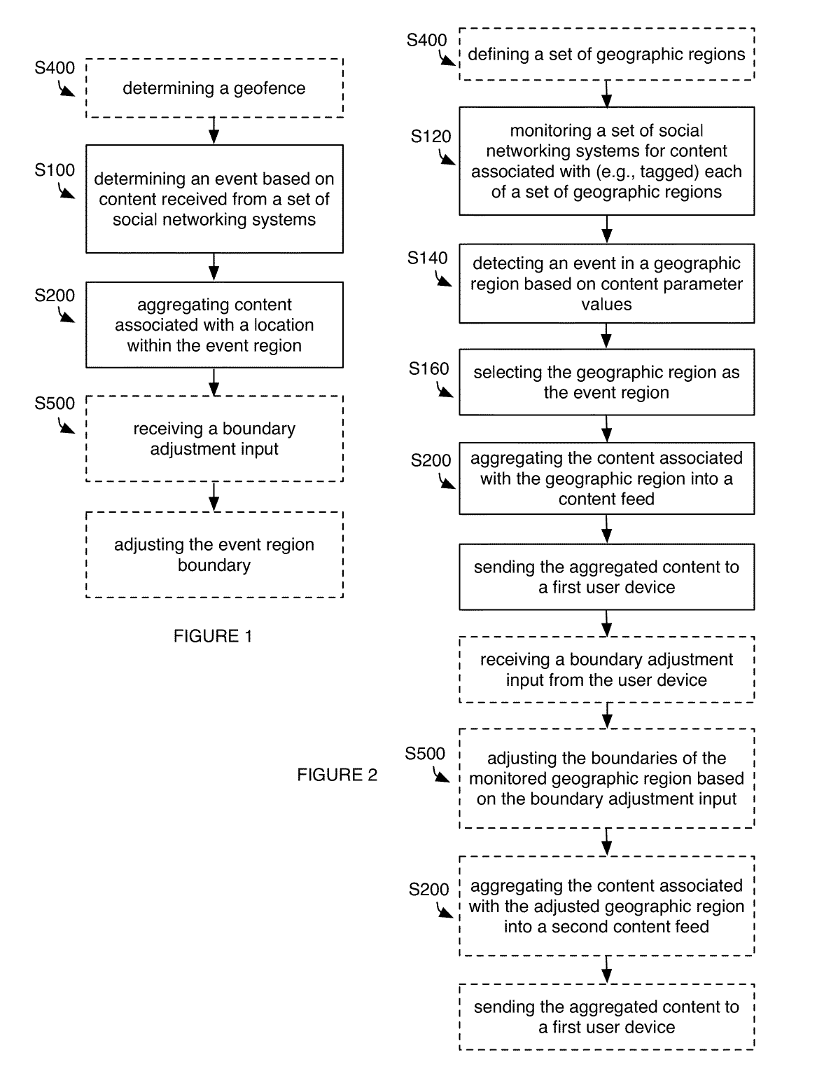

As shown in FIG. 1, the method for dynamic content curation includes determining an event based on content received from a set of social networking systems S100, and aggregating content tagged with a location within the event region S200. The method can additionally include determining a geofence S400 and adjusting a boundary in response to receipt of a boundary adjustment S500. This method is performed with an event boundary selection system, and can be used with or incorporated with a primary method that aggregates content 200 across one or more social networking systems 20 using geofences 100.

The method functions to enable a user 10 to dynamically create an event or curate content generated on one or more social networking systems based on the content location. Since the relevance of content to an event is highly dependent upon the geographic location from which the content was generated, the method enables better content curation by selectively including and excluding specific geographic locations from the event region. For example, when a user wants to create a content stream (content feed 240) of content related to a geographic location, the user can drop a pin or draw a loop (e.g., a closed loop) on a map displayed on a user device (e.g., create a geofence) and the method will return select content tagged or otherwise associated with the geographic location indicated by the geofence. The method controls (e.g., curates) the content to be returned by determining the event region from which the content should be drawn, and/or filtering the massive amount of social networking content using the event region. Instead of selecting content within a predetermined radius of a geographic location, the method selects content within the geographic area corresponding to a geofence. The method can additionally determine an event region having a unique shape (e.g., boundaries) in response to a user input, and select the content from the determined event region. The user input can be a geofence editing input, wherein the user edits the boundaries of the geofence, a content editing input, wherein the user edits (e.g., includes or excludes) the content published in a content feed associated with the event region, or any other suitable input.

The method can additionally function to curate the content displayed to a user by adjusting the event boundaries. Content previously excluded from the content stream because the respective tagged location was outside of the event region can be included when the new event boundary encloses the content location. Alternatively, content previously included in the content stream can be excluded when the adjusted boundary no longer encloses the referenced location. The method can additionally function to facilitate discovery of past content. For example, in addition to geofence creation, the user can specify a timeframe, wherein content from the determined event region that was generated during the specified timeframe can be returned. The determined event region can additionally be specific to the specific timeframe, such as when the timeframe corresponds to a widely disseminated event (e.g., a riot) and the specific event boundaries that delineated the nexus or focus of the event are known and/or can be determined. Alternatively, the timeframe can remain unspecified (e.g., in the instance of real-time event detection and content aggregation).

In a first variation, the method includes receiving content generated by a plurality of users from a plurality of social networking systems, identifying an event based on analysis of the content S140, selecting a geofence for the event from a set of predetermined geofences S160, aggregating content associated with (e.g., tagged with) a geographic location located within the first geofence into a content feed S200, and publishing the content feed to a first and second user device. The method can additionally include defining a plurality of geofences S420. The method can additionally include receiving a geofence adjustment input, such as a content filtering input or a geofence boundary adjustment input, from the first user device, and selecting a second geofence or generating a second geofence based on the geofence adjustment input S500. The second geofence is preferably generated from the first geofence, but can alternatively be a second predetermined geofence newly selected based on the adjustment input or determined in any suitable manner. In a specific variation, the second geofence can be selected to exclude a content location in response to exclusion of the respective content from the content feed by a user, and/or selected to include a content location in response to inclusion of the respective content into the content feed by a user. The method can additionally include publishing the resultant content feed generated based on the second geofence to a first and second user at different times, wherein publication to the second user (e.g., a non-editing user or a general user) can be delayed relative to publication to the first user.

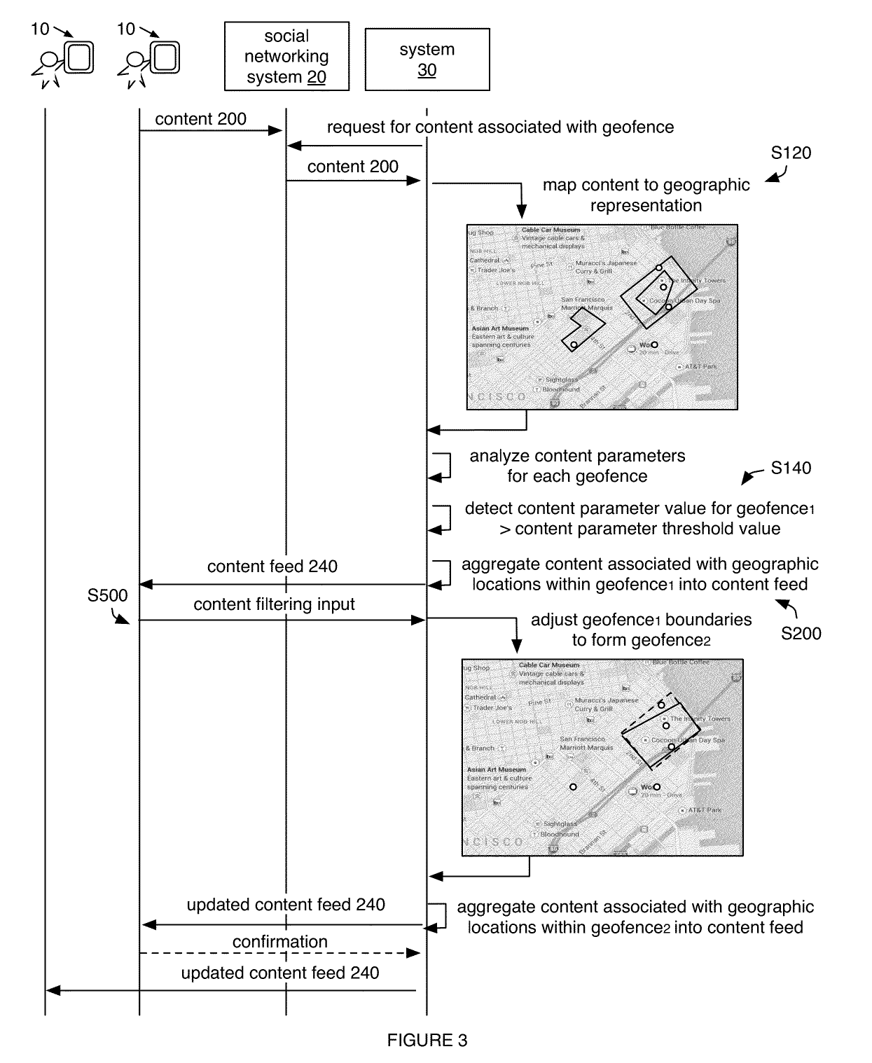

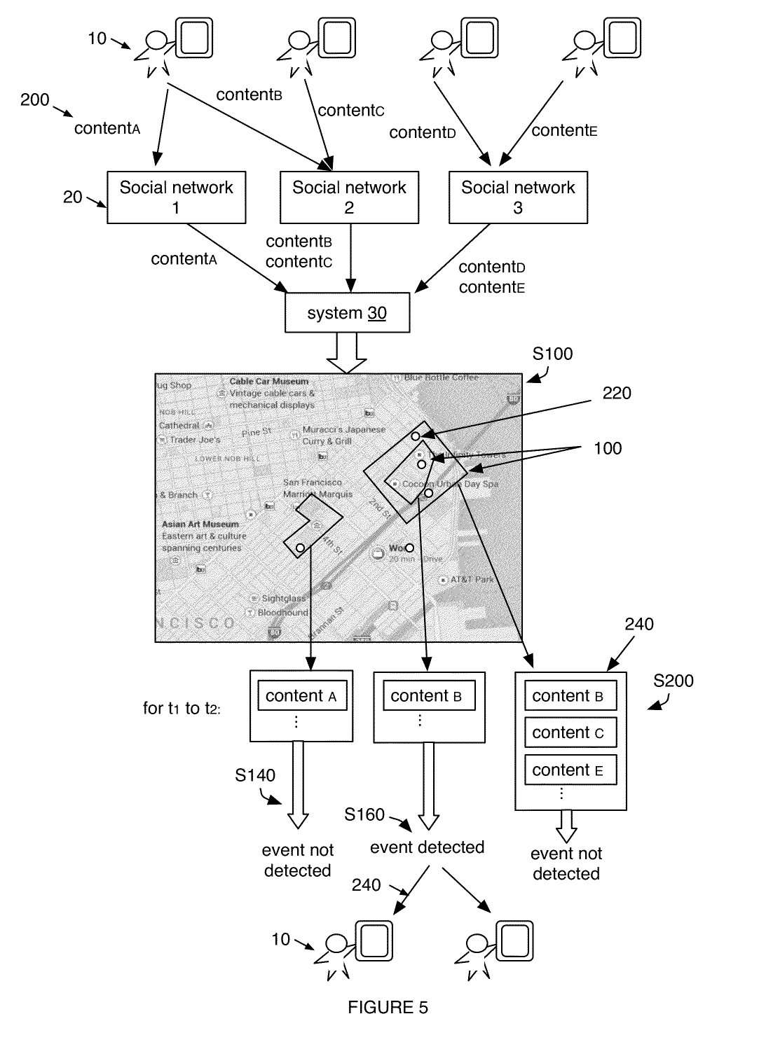

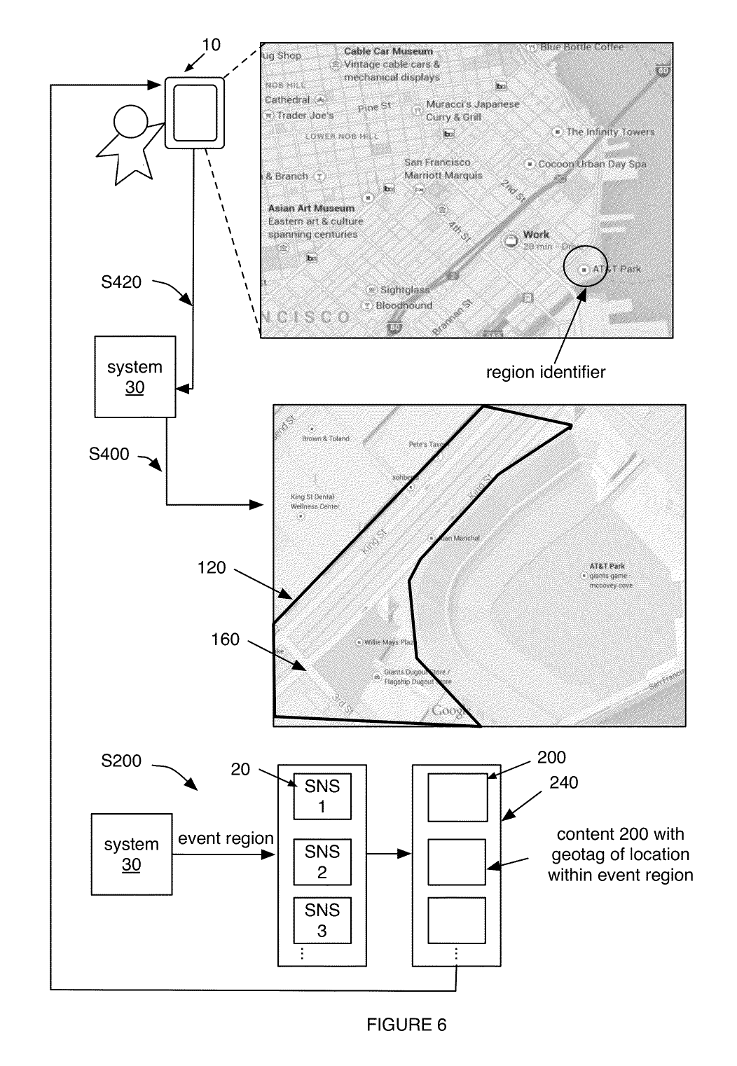

In a second variation as shown in FIGS. 2, 3, and 5, the method can include concurrently monitoring content associated with a plurality of predetermined geofences S120, selecting a geofence from the plurality of geofences in response to a content parameter for content associated with the geofence exceeding a threshold parameter value S140, aggregating content associated with the geofence into a content feed S200, and sending the content feed to a first user device. The method can additionally include defining a plurality of geofences S400. The content is preferably associated with a geofence through a geotag identifying a geographic location located within the geographic region bounded by the geofence, but can be otherwise associated with the geofence. Detecting that the content parameter has exceeded a threshold parameter value preferably functions to detect an event occurring in the geographic region bounded by the geofence. The content parameter is preferably a content generation or posting parameter, such as a content generation frequency or density of content associated with the geofence, but can alternatively be a content subject matter parameter, such as the frequency or density of references to a given subject matter or an event probability based on the content subject matter, or be any other suitable content parameter. The method can additionally include adjusting the geofence boundaries based on a boundary adjustment input S500.

An event is preferably an intersection of a physical region and a content parameter characteristic. The event can additionally be associated with a timeframe. The event can be predetermined (e.g., a planned event, such as an awards ceremony), recurring, spontaneous (e.g., a car crash), public, private (e.g., “work,” “at home,” etc.), or any other suitable intersection of time and location. The content parameter characteristic can be a volumetric characteristic (e.g., generation density or frequency), time-dependent characteristic (e.g., pattern of content generation over a period of time), subject matter characteristic (e.g., frequencies of mentions of specific subject matter topics), or any other suitable characteristic. The event timeframe can be a time period extending between a first timestamp and a second timestamp (e.g., UTC timestamp, GMT timestamp, etc.), but can be a time period extending from a first timestamp and unbounded by a second timestamp (e.g., an on-going event), or any other suitable timeframe. The physical region is preferably a geographic area, and can have any suitable resolution. Examples of physical regions include planets, continents, countries, states, counties, cities, communities, buildings, and rooms. The physical region preferably encompasses one or more physical locations (e.g., geographic locations, event locations, physical locations, etc.), wherein a physical location can be identified by a venue name, a user-defined name (e.g., “home”), a set of GPS coordinates, a set of latitude and longitude coordinates, a set of wireless cell tower triangulation information, an address, or any other suitable identifier for a physical location.

The method is preferably performed with a set of geofences 100, wherein the geofences can be predetermined or dynamically determined. Alternatively, the method can be performed with a set of spacefences, which can define a three-dimensionally limited space to be monitored. Each geofence 100 preferably includes an imaginary boundary enclosing a geographic region 160, wherein the boundary includes a set of imaginary segments 120 forming a closed loop encircling the geographic region. However, the boundary can alternatively include a circle or other shape defined relative to a geographic location (e.g., a center point), or be defined in any other suitable manner. The segments 120 are preferably linear segments, but can alternatively be curved or otherwise defined. The boundary preferably forms a geometric shape (e.g., a polygonal shape) and is preferably non-circular, but can alternatively define a circle or any other suitable shape.

The shape and size of the boundaries are preferably predetermined, but can be dynamically determined. In one variation, the shape, size, or any other suitable boundary parameter is determined based on the content frequency, density, or other content parameter. The geofences are preferably determined based on region identifiers, as discussed in S420, but can be otherwise determined. The geofences can be determined by a user, by a plurality of users (e.g., wherein the boundary is set or stored within the system after a threshold number of users select the boundary, within a predetermined accuracy threshold), automatically determined, randomly determined, determined based on physical barriers (e.g., run along a wall, etc.), determined based on political delineations (e.g., along a city border, country border, etc.), determined based on third party reference points (e.g., cell tower coverage areas, etc.), be predetermined geographic increments (e.g., 150 m by 150 m squares), or determined in any other suitable manner. The geofences can be entered by an administrator (e.g., a user with administrator permissions), determined when a threshold number of users have entered the same geofence (within a given degree of variability) within a threshold period of time, determined based on historical content generation densities over space (e.g., wherein the geofence is defined by the locations at which the content density falls below a threshold value), or defined in any other suitable manner.

Adjacent or contiguous segments of the geofence boundary are preferably connected at an anchor point 140, but can alternatively be otherwise connected. Boundary anchors are preferably imaginary points imposed upon a representation of a physical region (e.g., a map). The boundary anchors can be determined by a user, determined by a plurality of users (e.g., wherein the boundary anchor is set or stored within the system after a threshold number of users select the location as a boundary-defining point, within a predetermined accuracy threshold), automatically determined, randomly determined, determined based on physical or geographical barriers (e.g., run along a wall, etc.), set at predetermined intervals (e.g., a grid of boundary anchors imposed on the map), determined based on political, ethnographic, or other delineations (e.g., along a city border, country border, etc.), or determined in any other suitable manner.

Each geofence preferably includes a single boundary, such that a geofence encloses a continuous geographic region within the respective boundary. However, the geofence can include multiple boundaries, wherein the boundaries are preferably nested (e.g., such that the geofence encloses an annular region or a region is excluded from the geofenced region). Boundaries independently enclosing separate or overlapping geographic regions are preferably considered separate geofences, but can alternatively be considered part of the same geofence.

A plurality of geofences is preferably determined (e.g., predetermined or dynamically determined), but a single geofence can alternatively be determined. The geofences of the plurality can be overlapping, entirely separate, contiguous, or otherwise arranged. The overlapping geofences can be nested (inclusive), wherein a first geofence entirely encloses the geographic region enclosed by a second geofence. The nested geofences can be concentric, offset, or otherwise arranged. The plurality of geofences can include multiple sets of nested geofences, wherein each set can include multiple tiers of geofences. The geofences within each tier can be overlapping, entirely separate, contiguous, or otherwise related. In one example, the plurality of geofences can include a geofence for a state, a geofence for a city within the state, a geofence for a neighborhood within the city, and a geofence for a venue within the neighborhood, wherein content for all of the previously mentioned geofences can be simultaneously monitored. Alternatively, the overlapping geofences can encompass a shared geographic location or overlap in any other suitable manner. However, the geofences can be organized or defined in any other suitable manner.

Determining an event S100 functions to identify an event associated with a geographic region for which the content feed should be generated. More preferably, determining the event functions to determine which content out of the plurality of content should be included or excluded from the event-related content feed, but can alternatively be used in any other suitable manner. The event is preferably determined based on analysis of the user-generated content 200 posted to the plurality of social networking systems 20, but can alternatively be determined based on calendar events or any other suitable content. The content 200 can include text, video, audio, images, or any other suitable form of media. The content can additionally include metadata, such as a timestamp (e.g., of the generation time, the posting time, etc.), a geotag identifying a geographic location (content location 220), the generating user account, or any other suitable information.

The event is preferably a spontaneous event that is dynamically determined, but can alternatively be a pre-defined or user-defined event. A pre-defined or user-defined event is preferably an event wherein a combination of event parameters defining the event is explicitly received from or defined by a user, and can be a calendar event, a recurring event, or any other event defined in any other suitable manner. A spontaneous event is preferably dynamically determined from the parameters of non-calendar content (e.g., non-calendar events), wherein the combination of event parameters defining the event (e.g., event location or region, timeframe, attendees, etc.) is not pre-determined or received from a user (user-defined). The spontaneous event is preferably determined based on a content parameter value, wherein the event can be determined when the content parameter value exceeds a threshold value S140.

The content parameter value is preferably specific to a geofence, but can alternatively be universal. In one variation, content associated with locations located within each of a plurality of geofences are concurrently (simultaneously) monitored S120, wherein the event is detected in response to the content parameter value for the geofence exceeding the content threshold parameter value for the geofence. The content for each geofence can be aggregated and/or analyzed at a predetermined frequency, in response to generated content associated with the geofence, or at any other suitable frequency. In this variation, the content can be requested from the set of social networking systems for each of the geographic region enclosed by the geofences. In a second variation, content is received from the set of social networking systems and associated with the geofences encompassing the geographic location associated with the respective piece of content (e.g., filtered by the geofences based on the respective geotag). In this variation, determining the content parameter value for the geofences can include determining the content parameter values across a large geographic area encompassing the content geographic locations, identifying geographic areas exhibiting content having parameter values over the threshold parameter value, and identifying the geofences encompassing the identified geographic areas. However, the content parameter value can be otherwise determined for each of a plurality of geofences.

The content parameter value is preferably determined for each geofence based on content received or posted during predetermined time segments, but can be determined in any other suitable manner. For example, the content parameter value for a geofence can be determined in 1 millisecond increments, wherein the content parameter value for each millisecond is determined based on content associated with locations in the geofenced area that were posted during each monitored millisecond. However, the content parameter value can be determined for a unique time duration defined by a first and second unique timestamp, determined for any suitable increment of time, or determined in any other suitable manner.

In a first variation, the content parameter is the subject matter of the content, wherein an event is detected in response to content having similar subject matter (e.g., as determined using natural language processing, topical relationship trees, etc.) being generated at a higher density, frequency, or number than a threshold density, frequency, or number. However, the spontaneous event can be determined based on any other suitable content subject matter parameter value surpassing any other suitable content subject matter parameter threshold. In a second variation, the content parameter is a frequency parameter, more preferably a content generation or posting frequency. An event can be detected in response to content being generated beyond a threshold frequency. In a third variation, the content parameter is a density parameter, more preferably a content generation or posting density, wherein an event is detected in response to the density of content exceeding a threshold density. In this variation, the posting density can be an absolute density (e.g., inclusive of all content ever posted), a density over a period of time (e.g., a predetermined testing time, the event duration, etc.), or limited temporally in any other suitable manner. However, the content parameter can be any other suitable parameter characterizing the content.

The threshold parameter value is preferably specific to a geofence, but can alternatively be universal. The threshold parameter value is preferably automatically determined, but can alternatively be determined by a user. The threshold parameter value can be selected, calculated, or otherwise determined. Each geofence is preferably associated with a different parameter threshold value, but can alternatively be associated with the same threshold parameter value. The threshold parameter value can vary based on time (e.g., time of day, day of week, month of year, etc.) or be substantially constant over time. The threshold parameter value can vary based on the type of detected event (e.g., based on the subject matter of the content), but can alternatively be fixed. The content threshold parameter value can be based on the respective geofence size (e.g., size of the enclosed geographic region), wherein the threshold value can be directly correlated with the geofence size (e.g., increase with increasing size), be indirectly correlated with size, or be otherwise correlated with a parameter of the geographic region bounded by the geofence. The content threshold parameter value can be based on the types of venues and/or parameters of venues (e.g., venue density) enclosed within the respective geofence, wherein the threshold parameter value associated with the type of venue or venue parameters can be determined based on historical parameter values for the venue or similar venues, user-determined, or otherwise determined. In a first example, a geofence enclosing a stadium can be associated with a higher threshold parameter value (e.g., content generation or posting frequency or density) than a geofence enclosing a coffee shop. In a second example, a geofence enclosing only a stadium can be associated with a higher threshold parameter value than a geofence enclosing the stadium and the areas surrounding the geofence. The content threshold parameter value can be based on the historical content activity within the geofence. For example, the threshold parameter value can be equal to or determined from a historical content parameter value or pattern for the geofence at a past time that shares attributes with the monitoring time (e.g., having a similar time and/or date). The historical content activity can additionally or alternatively be used to normalize the threshold parameter value. However, the content threshold parameter value can be otherwise determined.

Determining the event S100 can additionally include determining the event region S160 and determining an event timeframe S180, or determining any other suitable event parameter.

Determining an event region S160 functions to identify the boundaries of a geographic region that, when used to filter content, results in content that is highly relevant to the event associated with (e.g., occurring in a region including) the identified region. The event region is the geographic or physical region or area enclosed by event boundaries. The event region is preferably defined by a geofence, but can alternatively be defined by any other suitable set of boundaries. The event boundaries are preferably imaginary lines (e.g., digital lines) imposed upon a representation of a physical region (e.g., a map), but can alternatively be physical or geographic barriers (e.g., a wall, mountain, shoreline, etc.) or be any other suitable means of defining a boundary.

The event region is preferably dynamically determined S160 in response to receipt of the region identifier, but can alternatively be determined in response to a content parameter value surpassing a parameter threshold value S140, preselected, or be performed at any other suitable time. Determining an event region preferably includes selecting a geofence or new set of event boundaries that enclose or approximate the identified or estimated event region.

Selecting the event boundary can include selecting the geofence for which the respective content threshold parameter value is satisfied (e.g., the parameters of the content tagged with geographic locations within the geographic region enclosed by the geofence exceed or otherwise satisfy the respective parameter threshold). Selecting the event boundary can alternatively or additionally include selecting an event boundary from a database of event boundaries (e.g., geofences), dynamically determining the event boundary, or otherwise determining the event boundary. One or more event regions, each enclosed by an event boundary, can be simultaneously selected for an event based on the region identifier. For example, when the identified region is Golden Gate Park, SF, and the timeframe or content subject matter indicates a concert, multiple locations, each corresponding to an area in front of an individual stage, can be selected. Selecting the event boundary from a database can include identifying an event boundary within the database based on the name, category, or other parameter of the event, wherein the event parameter is preferably extracted from the content subject matter, but can alternatively be retrieved from a database based on the content timestamps and/or locations, or otherwise determined. The event boundary is preferably associated with a combination of one or more event parameters, score generated therefrom, or otherwise associated with an event characterization. Selecting the event boundary can additionally or alternatively include searching the event boundary database for a geofence enclosing all or a portion of the identified region, or a geofence enclosing all or a threshold portion of the locations of the event-associated content. Selecting the event boundary can additionally or alternatively include searching the event boundary database for a geofence enclosing all or a portion of the geographic locations exhibiting a content parameter value of interest (e.g., a posting frequency or density of interest). Selecting the event boundary can additionally include adjusting or selecting the event boundary based on the type of event. The event boundary is preferably associated with the event within the database, but can alternatively be associated with a region identifier within the database (e.g., associated with a venue name, etc.). The event boundary or geofence defining the boundary of the event can be automatically determined, determined by an administrator, or determined in any other suitable manner.

Selecting the event boundary or geofence can include selecting the event boundary based on the density of generated content over the general region (e.g., area in which the region identifier is located) within event timeframe or within a predetermined time period. The event boundary can be defined by the locations at which the content density falls below a threshold value, but can be otherwise defined based on the content density. For example, the event boundary can trace boundary anchors or physical locations at which content generation frequency or content density drops below a threshold frequency or density. In a specific example, the majority of the content is generated at the red carpet during an awards show, and a minority of the content is generated within the event hall. The event boundary is preferably defined about the red carpet at the beginning of the red carpet, and moves toward the event hall as the event away from the red carpet as the awards show progresses. Dynamically selecting the event boundary can additionally or alternatively include selecting the event boundary to meet a minimum content volume. For example, the event region can be expanded when the volume of content geotagged with a location within the event region and generated by unique users within the event timeframe is below the threshold volume.

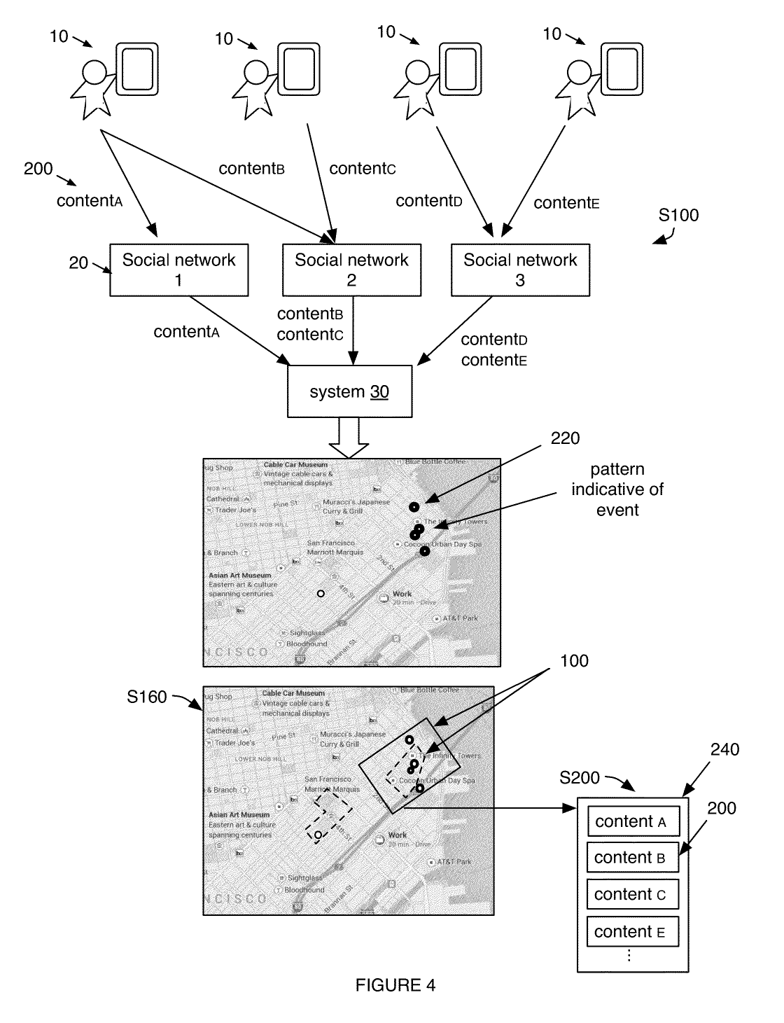

Selecting the event boundary can alternatively include selecting a set of boundary anchors. Selecting the set of boundary anchors can include selecting boundary anchors that are closest to (e.g., most proximal) the received boundaries. Selecting the set of boundary anchors can also include selecting boundary anchors that are typically associated with the specific event or event type in the identified region (e.g., a first set of boundary anchors are selected for AT&T Park for a baseball game, while a second set of boundary anchors different from the first set are selected for AT&T Park for a concert). Selecting the set of boundary anchors can also include selecting boundary anchors that form a boundary outline or pattern typically associated with the specific event or event type (e.g., as shown in FIG. 4). Selecting the set of boundary anchors can also include selecting boundary anchors that were previously selected by curating users and/or were established when a threshold number of users had selected the set of boundary anchors, within a variance threshold. This variation can be preferred when the event is on-going. In one example of this variation, a first user identifies a region and a first region boundary bounding a first event region is selected for the identified region. When a second user identifies a location within the first event region, the first region boundary bounding the first event region is selected for the second user. Selecting the set of boundary anchors can also include selecting boundary anchors that enclose the location of influencers (e.g., celebrities, politicians, tastemakers, etc.) within the identified region or within a threshold distance from the identified region. The influencer locations are preferably extracted from the content generated by influencer-associated accounts on one or more social networking systems. Alternatively, the influencer locations can be identified from secondary content or media, such as a live video stream, from content generated by non-influencers that include or reference the influencer (e.g., a geotagged image of the influencer, a geotagged text referencing the influencer account and including a proximity keyword such as “near,” etc.), or from any other suitable secondary content.

Determining an event region S160 can additionally include displaying the event region or the event boundary to the user. The event region and/or event boundary is preferably displayed over a map on a user device, but can alternatively be otherwise displayed. Displaying the event region and/or event boundary can additionally include displaying content identifiers for content tagged with locations inside and outside the event region, wherein the content identifier (e.g., an image, video, author image, etc.) is preferably extracted from the respective content. Displaying the event region and/or event boundary can additionally include displaying the boundary anchors proximal the event region. In this variation, the user can drag a segment of the event boundary to an available boundary anchor to change the shape of the event region.

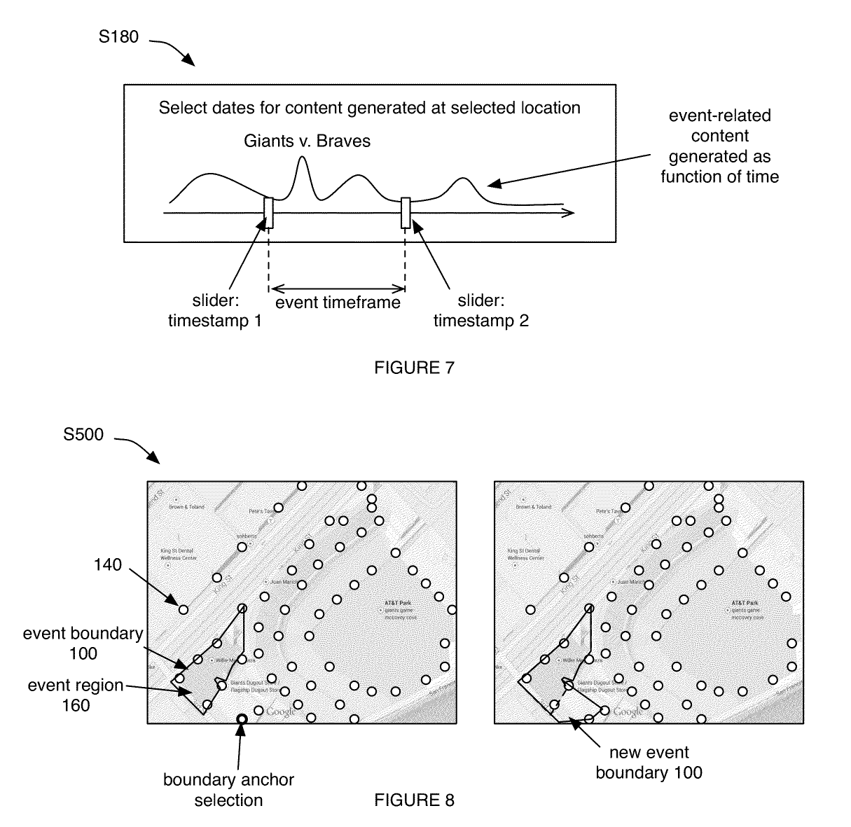

Determining an event timeframe S180 functions to define a time period that can be used to filter content. The content aggregated into the content feed are preferably tagged with a time (e.g., have a post timestamp) within the event timeframe, but can be tagged with a time outside of the event timeframe or be content having any other suitable relation to the timeframe. The event timeframe is preferably a predetermined time duration prior to the time at which the region identifier was received, but can alternatively be a time selection received from the user (e.g., as shown in FIG. 7), a timeframe determined based on the region identifier (e.g., from a database associating the region identifier with the timeframe based on a predetermined event), or be a timeframe identified in any other suitable manner. For example, the time duration and/or event timeframe can be received from the user at a slider (e.g., wherein the slider corresponds to how far in the past the content should be retrieved from), at a calendar (e.g., wherein a first and a second time/date selection form the first and second timestamps bounding the timeframe, respectively), received at a text entry field, or received in any other suitable manner.

Aggregating content generated within the event region during the event timeframe S200 functions to select content for the content feed. Aggregating content associated with an event can be accomplished using the method disclosed in U.S. application Ser. No. 14/043,479 filed 1 Oct. 2013, incorporated herein in its entirety, but can be otherwise performed. The content feed is preferably geofence-specific, and can additionally be event-specific. Each geofence is preferably associated with a content feed, wherein the content feed is preferably specific to the geofence but can alternatively be shared with one or more secondary geofences. Content associated with the geofence (e.g., content associated with a geographic location inside of the geographic region bounded by the geofence) is preferably aggregated into the content feed associated with the geofence, while content unassociated with the geofence (e.g., content associated with a geographic location outside of the geographic region bounded by the geofence) is preferably excluded from the respective content feed. More preferably, content associated with the event (e.g., sharing a keyword, content-generating user, subject matter, etc.) from the geographic location is preferably included in the event-associated content feed, while content associated with the geographic location but not the event (e.g., as determined from content subject matter, keywords, etc.) are preferably excluded from the content feed.

The aggregated content can include content geotagged with a location within the event region. The aggregated content can additionally have a post timestamp within the event timeframe. The content feed is preferably presented to one or more secondary users, but can alternatively be only provided to the user that defined the event region. The content feed is preferably public, but can alternatively be semi-private or private (e.g., accessible through login or access permissions entered by the primary user). In one variation of the method, aggregating content can include searching one or more social networking systems for content tagged with a location within the event region and within the event timeframe. The identified content is then retrieved (received) and aggregated into the content feed. In another variation of the method, content can be retrieved from the one or more social networking systems and filtered using the event region and the event timeframe, wherein the resultant content is aggregated into the content feed. In another variation of the method, the system monitors the set of social networking systems for content generated by one or more users known or anticipated to be at the event (e.g., wherein the corresponding user accounts are monitored for content generated within the timeframe), wherein any content generated by the monitored users are aggregated into the content feed. In a third variation of the method, the system monitors the set of social networking systems for content generated in association (e.g., tagged or otherwise assigned) with geographic locations located within one or more of a set of geofences, wherein any generated content associated with a geofence is aggregated into a content feed associated with the geofence.

Content can be associated with abstracted locations referencing a geographic region (e.g., obfuscated locations, geotags referencing a plurality of non-unique geographic locations such as a city, state, or country, etc.), wherein the abstracted locations preferably do not reference a unique geographic location, but rather references a geographic region encompassing a plurality of geographic locations. However, the abstracted location can reference a single unique geographic location (e.g., set of longitude and latitude coordinates, altitude coordinates. etc.) or reference any other suitable set of locations. In one variation, this content can be treated as located within all geofences encompassing geographic locations within the referenced geographic region. The content can be considered as located within all geofences fully enclosed by the referenced region, but can alternatively be considered as located within geofences that partially overlap the referenced region, or considered as located within any other suitable geofence. In this variation, the content is aggregated into the content feeds associated with the geofences that the content is considered located within. For example, content tagged with a state identifier (e.g., “California”) can be included in content feeds associated with geofences identifying the state, counties within the state, cities within the counties, neighborhoods within the cities, and/or venues within the neighborhoods. Additionally or alternatively, abstracted locations can be associated with a subset of the tiered geofences. For example, the content tagged with a state identifier can be included in content feeds associated with the state, counties, cities, and neighborhoods, but not included in content feeds associated with the venues. The limiting tier can be predetermined, determined by a user, determined based on the tier associated with the abstracted location, or determined in any suitable manner. In a second variation, content with abstracted locations can be treated as only located within the geofences substantially matching or surpassing the referenced geographic region. For example, content tagged with “California” can be considered to be located within (and therefore aggregated into content feeds associated with) a California state geofence and a United States geofence, but will not be considered to be located within a “San Francisco” geofence, because the “San Francisco” geofence encompasses a geographic region smaller than the geographic region referenced by the content “California” tag. However, content with abstracted location data can be weighted to determine whether the content should be included in a content feed, or treated in any other suitable manner.

Aggregating the content into the content feed can additionally include filtering the content for select media types. For example, filtering the content feed for select media types can include filtering the content to select content including images or video. Aggregating the content into the content feed can additionally include filtering the content to normalize the volume of content from different sections of the event region. Aggregating the content into the content feed can additionally include selecting content including or related to a given keyword (e.g., hashtag), event name, or other event-associated terms.

Aggregating the content into the content feed can additionally include automatically filtering the content for subject matter. Filtering the content feed for subject matter can include identifying subject matter having parameters beyond a threshold subject matter parameter value and filtering the aggregated content to retain the content pertaining to the identified subject matter in the content feed. The subject matter parameters can include the volume of content referencing the subject matter, the frequency of subject matter reference, the geographic density of content referencing the subject matter, the types of media used to reference the subject matter (e.g., wherein some media types are weighted heavier than others), the rate of change of subject matter references, sentiment surrounding the subject matter, or any other suitable parameter characterizing subject matter popularity. However, the aggregated content can be filtered in any other suitable manner.

Aggregating the content into the content feed can additionally include accommodating for device inaccuracies. Accommodating for device inaccuracies preferably include accommodating for inaccuracies in geotagging or location identification, but can alternatively include accommodating for timestamp inaccuracies or for any other suitable inaccuracy due to the content-generating device. The inaccuracies are preferably provided by the content-generating device, but can alternatively be otherwise determined. Device inaccuracies are preferably accommodated for when the tagged location is outside of event region, but the inaccuracy radius or region overlaps with event region. Content having such inaccuracies are preferably included in the content feed, but can alternatively be excluded from the content feed. However, the inaccuracies can be otherwise accommodated for.

The method can additionally include defining a geofence S400, which functions to receive geofences for subsequent monitoring. Defining the geofence can include receiving a region identifier S420 and defining the geofence based on the region identifier.

Receiving the region identifier S420 functions to receive an indication of a physical region of interest to a user. The region identifier 102 can be received from a user, received or selected from a database, automatically determined based on historical content generation densities, frequencies, or another parameter, automatically determined based on physical, political, ethnographic, or entity-defined barriers or divisions, or determined in any other suitable manner. The region identifier is preferably a geofence enclosing a geographic region, but can alternatively be a region name, a set of coordinates, or any other suitable region identifier. The region identifier is preferably directly or indirectly associated with a geofence enclosing a geographic region identified by the region identifier. The region identifier can be received from the user at a user device. The region identifier is preferably a selection received at a map displayed on the device, but can alternatively be received as a text input, as an image input (e.g., wherein the image is extracted and analyzed, such as through image matching, to determine a location), or received in any other suitable form. The region identifier can be a selection of a point on the map (e.g., a dropped pin in response to a touch selection, cursor selection, etc.) or a selection of a region on the map.

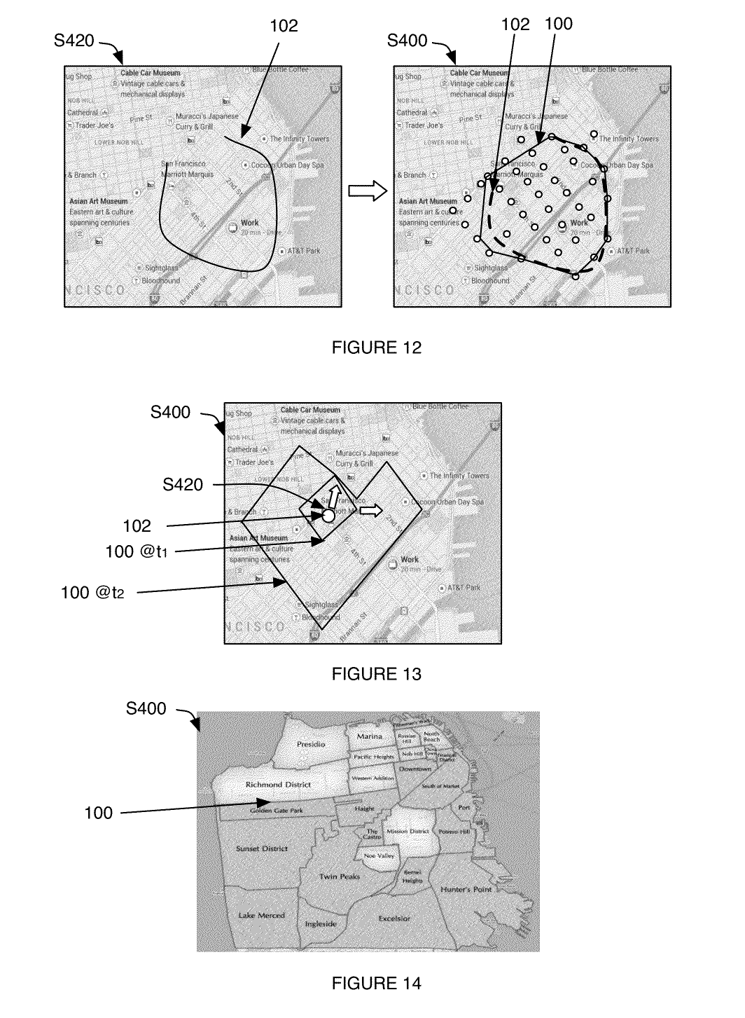

A geofence is preferably defined S400 based on the region identifier. The geofence associated with the region identifier preferably encloses all, a portion of, or more than the map region identified by the region identifier, but can alternatively enclose any other suitable geographic region. In a first variation of determining the geofence, a map region enclosed by the geofence can be selected by receiving a location selection (region identifier) and expanding the highlighted or identified region as a function of the selection duration. For example as shown in FIG. 13, selecting a location on the map can select the respective coordinates as the region identifier, and holding the selection beyond a given threshold (e.g., receiving a substantially continuous touch) can select increasingly larger geographical regions about the respective coordinates (e.g., increase from a point to the boundaries of the building that the point is located in, to the boundaries of the district that the building is located in, to the city that the district is located in, etc.). Alternatively, the geofence can be selected by receiving approximate boundaries from the user on a displayed map. For example as shown in FIG. 12, the user can circle, outline, or otherwise indicate selection of a map region with a continuous line, wherein the line can be enclosed or disconnected. In one example, the system will determine the set of anchor points closest to the geographic locations along the loop path, and automatically generate boundary segments connecting the anchor points of the set, such that the resultant geofence and enclosed geographic region approximates the loop and geographic region enclosed by the loop, respectively. Alternatively, the system can identify the geographic region enclosed by the loop and select a predetermined geofence enclosing approximately the same geographic region. Alternatively, the system can identify the set of anchor points most proximal the loop, edit the anchor points included in the set by applying anchor point rules to the set, and connect the resultant anchor points to form the geofence. The anchor point rules can include a rule that only anchor points that are located within or define a contiguous space (e.g., wherein the space is not separated by a predetermined physical barrier) can be included in the set, a rule that the set is limited to specific combinations of anchor points, or any other suitable rule. Alternatively, the user can select the geofence boundaries by selecting a series of boundary anchors, wherein the indicated region can be the region enclosed by a series of lines or splines connecting the selected boundary anchors.

In a second variation, the region identifier can be determined from a database. In a first embodiment, the database preferably includes one or more events, wherein the event can be associated with an event location. Upon receipt of an event selection from a user, the event location can be selected as the region identifier, and a geofence generated based on the event location (e.g., based on the boundaries of a specified venue). However, the region identifier can be otherwise selected or determined. Event details, such as keywords, a timeframe, user accounts to track for content, or any other suitable event detail, can additionally be received from the user. Alternatively, the system can automatically determine the event details from a set of databases (e.g., public event listings, emails, calendar information, etc.). In a second embodiment, the region identifier is received from a database storing a plurality of predetermined region identifiers associated with predetermined geographic boundaries, wherein geofences are generated according to the predetermined geographic boundaries. For example, as shown in FIG. 14, the database can be a map database (e.g., including geographical and/or political boundaries), construction database (e.g., including building boundary information), or any other suitable database. However, the geofence can be otherwise determined.

The method can additionally include adjusting a boundary or event boundary S500 in response to receipt of a boundary adjustment, which functions to better tailor the event region and event boundary to filter for content that is more relevant to the user and/or event. The boundary can be adjusted in response to receipt of a boundary anchor adjustment, in response to receipt of an input including or excluding content from the content stream (content filtering input), or in response to receipt of any other suitable indication that the event boundary should be changed. The boundary can be adjusted such that boundary traces the shortest path between the available boundary anchors. Alternatively, the boundary can be adjusted by including a new boundary anchor into the set associated with the boundary and excluding an old boundary anchor from the set, such that a first and second contiguous or adjacent boundary segment are connected to the new boundary anchor and disconnected from the old boundary anchor. The new boundary anchor is preferably selected to exclude an identified geographic location from, or include the identified geographic location into, the geographic region enclosed by the geofence. The anchor point rules can be applied or ignored in selecting the new anchor point. Alternatively, the boundary can be adjusted such that the boundary traces physical or political barriers. Alternatively, the boundary can be adjusted by selecting a second predetermined geofence or event boundary that substantially satisfies the desired boundary adjustment (e.g., encompasses and/or does not encompass the geographic locations to be included and/or excluded, respectively). The boundary that is adjusted can be a predefined geofence, a dynamically created geofence, an event boundary created by the adjusting user, an event boundary that was created by another user, or any other suitable boundary.

In a first variation of the method, an example of which is shown in FIG. 8, the event boundary is adjusted in response to receipt of a boundary anchor adjustment from a user. In response to receipt of a user selection of an event boundary segment (e.g., as rendered on a map) and selection of a second boundary anchor or a second location (e.g., arbitrary location on the map), the event boundary is preferably adjusted such that the event boundary passes through the second boundary anchor or the second location. Alternatively, the event boundary can be adjusted in response to receipt of a location selection outside of the event region, wherein the event boundary can be adjusted to include the selected location. The location selection can be limited, restricted, or selection hindered. For example, the locations available for selection can be limited to locations within a space defined by physical barriers. In another example, selection of locations separated from the current event region by a wall can be hindered (e.g., do not induce an event region adjustment until the location selection is maintained or held for a predetermined period of time).

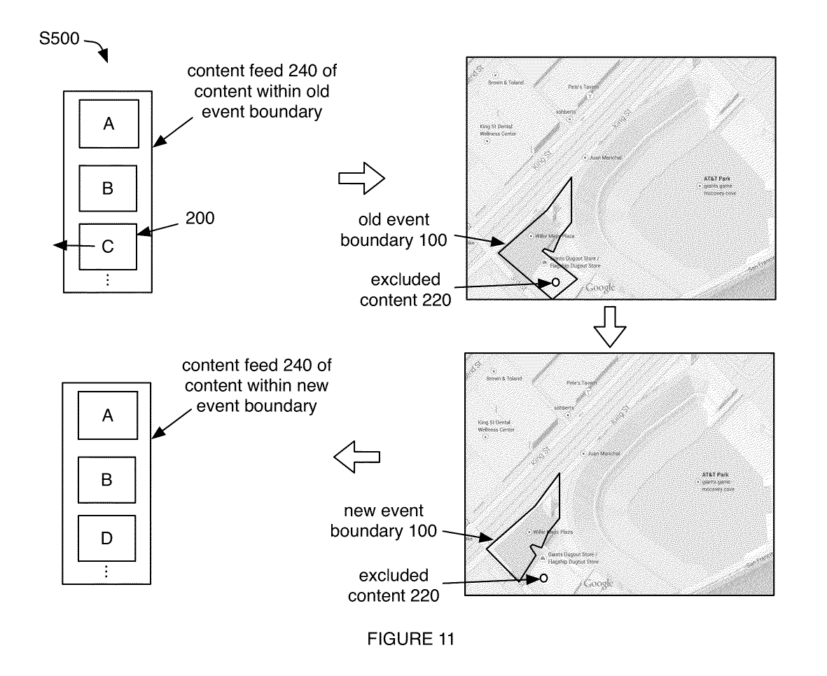

In a second variation of the method, an example of which is shown in FIGS. 11 and 10 respectively, the event boundary is adjusted in response to receipt of content exclusion from or inclusion into the content feed. Content can be excluded from the content feed by downvoting the content, swiping to remove the content, having a viewed or screentime below a threshold view time, or otherwise excluded in response to determination of user disinterest. When the content excluded from the content feed, the location associated with the content (e.g., through the content geotag) can be determined and the event boundary can be adjusted to exclude the location of the respective content. The event boundary can be adjusted after a threshold number of content associated (e.g., tagged) with the location or a nearby location has been excluded from the feed, or be adjusted in any other suitable manner based on the excluded content. Content can be included into the content feed by dragging content into the content feed, viewing the content, upvoting the content, linking the content to the content feed, or otherwise indicating interest in the content. The content, while initially excluded from the content feed, can be presented to the user as a secondary feed that aggregates secondary content having locations near the event region. When the content included into the content feed, the location associated with the content (e.g., through the content geotag) can be determined and the event boundary can be adjusted to include the location of the respective content. The event boundary can be adjusted after a threshold number of content associated (e.g., tagged) with the location or a nearby location has been included into the feed, or be adjusted in any other suitable manner based on the included content. However, the event boundary can be otherwise adjusted.

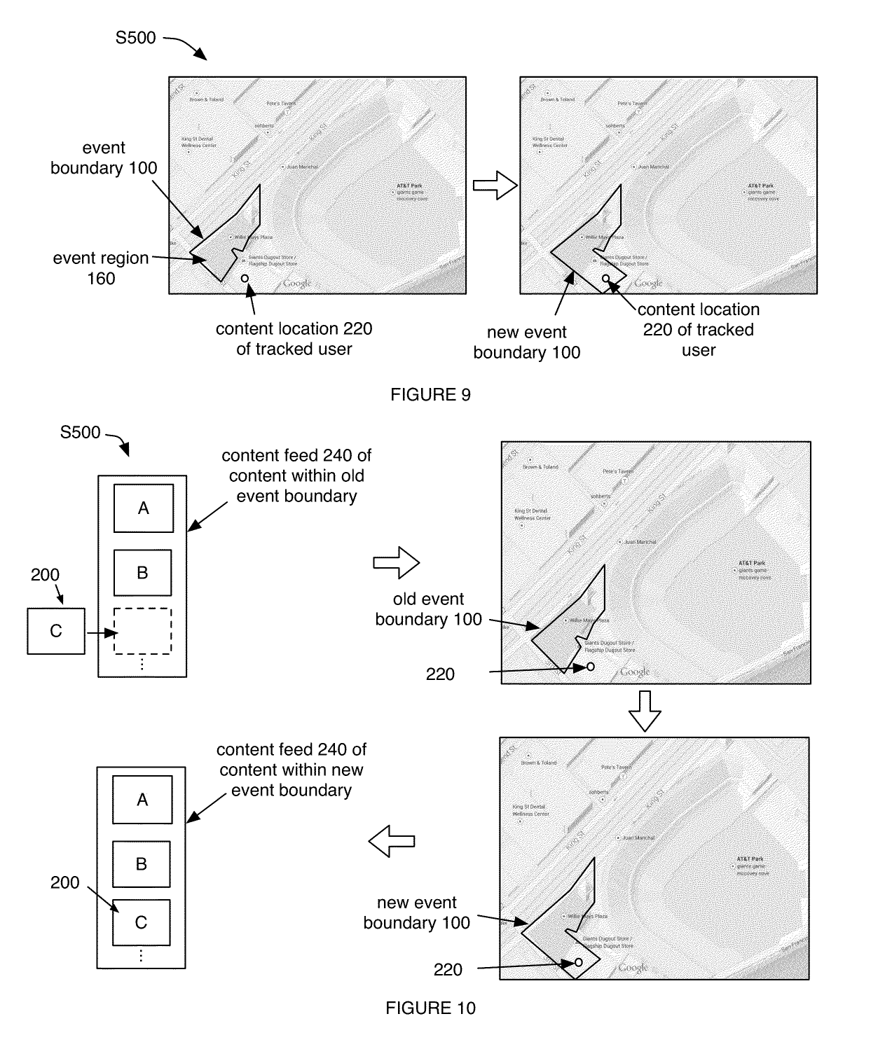

In a third variation of the method, an example of which is shown in FIG. 9, the event boundary is adjusted in response to detection of content generated by a tracked user (e.g., an influencer account) associated with (e.g., geotagged with) a location outside of the event region. The content location is preferably extracted and a new event boundary is selected that encompasses the content location.

Adjusting the event boundary can additionally include reinforcing locations within the event region. More specifically, the locations associated with content of interest within the content feed (preferred locations) can be reinforced, such that any event boundary adjustment preferably includes the preferred locations. Content of interest can include content having upvotes beyond a predetermined threshold, content having individual view times beyond a predetermined time threshold, or content satisfying any other suitable condition of user interest. Reinforcing locations within the event region can additionally adjust the distribution of content locations represented by the content within the content feed. For example, when posts from a first location are deemed more interesting than posts from a second location, more posts from the first location can be included within the content feed, while the number or frequency of posts from the second location can be reduced.

When the event boundary adjustment is received from a user, the event boundary is preferably immediately changed for the user, wherein the content aggregated into the content feed preferably immediately reflects the event boundary change (e.g., only includes content tagged with locations within the new event region, and excludes content tagged with locations previously included by the old event region and excluded by the new event region). The event boundary adjustment induced by the user is preferably delayed for other users (e.g., not immediately reflected in other user's content feeds) until a push condition has been satisfied. In response to the satisfaction of the push event, the new event boundary is used to filter content for other users that are viewing the content feed for the same event. The push event can be satisfied when the number of users adjusting the event boundary to the new boundary exceeds a predetermined threshold, when an event administrator adjusts the event boundary to the new boundary, when an influencer adjusts the event boundary to the new boundary, when content generated by an influencer associated with the event (e.g., by industry or event category) is detected to be outside of the event boundary, or can be satisfied when any other suitable condition that indicates a location shift in the event focus.

Whether the event boundary is adjusted for the user population can additionally be based on the quality of the boundary change. The quality of the boundary change can be based on the user's boundary change history, but can alternatively be based on any other suitable factor. The event boundary is preferably adjusted when the quality of the boundary change is high, and not adjusted for the user population when the quality of the boundary change is low. Examples of high quality boundary changes include a low frequency of boundary changes from the user after the respective boundary change, an increase in detected user interest in the content from the newly included region, and use of the new event region beyond a predetermined period of time. Examples of low quality boundary changes include a high frequency of boundary changes from the user after the respective boundary change, high frequency of region area changes (e.g., rapid fluctuations between large event regions and small event regions), a decrease in detected user interest in the content from the newly included region, or determination that the boundary change was undone. However, the quality of the boundary change can be otherwise measured. Whether the event boundary is adjusted for the user population can additionally be based on a user ranking (e.g., changed when the user has an influence score beyond an influence threshold), user permissions (e.g., changed when the user has administrator permissions), or changed based on any other suitable user parameter.

The method can additionally include providing event region recommendations based on information from a user's calendar. In one variation of the method, calendar information is used to determine the events that the user will attend in the future. This information can be used to prompt the user to create an event region and/or curate content at the date and time of the anticipated event. In another variation of the method, calendar information is used to determine the events that the user attended in the past. This information can be used to prompt the user to curate content associated with the past event. In another variation of the method, calendar information is used to determine where the user is supposed to be at the substantially instantaneous moment, wherein the information is used to adjust the content ranking within the substantially instantaneous content feed.

The method can additionally include providing event region recommendations based on user interests. User interests can be derived from newsfeeds accessible through saved information on the user device, user purchase histories, music stored on the user device and/or in a user cloud account, or any other suitable information accessible through an operating system on a user device. The user can be prompted to curate and/or create events based on the determined interests. The method can additionally recommend content feeds for past, present, or future events that match and/or are related to the user interests. The user interests can additionally be used to adjust the ranking of individual pieces of content within the content feed.

The method can additionally include adjusting the event region based on accelerometer data. This can be used when the accelerometer data is from the device of an influential user or a user with administrator permissions. In one variation of the method, the accelerometer data is used to determine the direction that the event region will move, wherein the event boundary is preferably continually adjusted beyond the current location of the device, in the direction indicated by the accelerometer. In another variation of the method, the accelerometer data is used to determine when the event boundary should be adjusted. For example, the event boundary can be changed whenever the accelerometer data indicates movement beyond a predetermined threshold. However, the accelerometer data can be used to adjust the event boundary and/or adjust the order of the content presented within the content feed in any other suitable manner.

The method can additionally include identifying an event by monitoring content associated with each of a plurality of event regions each defined by a different boundary (e.g., polygon). An event is preferably identified in response to the generation frequency of content associated with the event region exceeding a predetermined threshold (e.g., 1 post/minute). Alternatively, the event can be identified in response to the total number of content associated with the event region exceeding a predetermined threshold within a threshold period of time (e.g., within an hour). Alternatively, the event can be identified in response to the satisfaction of any other suitable event identification condition. The event is preferably determined in near-real time, but can alternatively be determined any suitable amount of time after event identification condition satisfaction. The content can be from a set of continuously or periodically monitored social networking services, but can alternatively be retrieved from any other suitable content source. The content is preferably generated by multiple users (e.g., over a threshold number of users), but can alternatively be generated by a single user. A notification is preferably sent to a user (e.g., a news outlet, a social networking service user, etc.) in response to identification of the event. A content feed can additionally be generated in response to satisfaction of the event identification condition for the associated event region, and can be sent to or otherwise presented to the user (e.g., in response to selection of the notification).

An alternative embodiment preferably implements the above methods in a computer-readable medium storing computer-readable instructions. The instructions are preferably executed by computer-executable components preferably integrated with a content curation system 30. The content curation system can include a content aggregation system that functions to receive content from the social networking systems and process (e.g., geotag) the content, geofence analysis system that functions to assign content to one or more geofences and determine the content parameter values for each geofence, and an event detection system that functions to evaluate the content parameter values for each geofence, detect whether an event is occurring within the geofence, and select the geofence as the event location. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

Although omitted for conciseness, the preferred embodiments include every combination and permutation of the various system components and the various method processes.

As a person skilled in the art will recognize from the previous detailed description and from the figures and claims, modifications and changes can be made to the preferred embodiments of the invention without departing from the scope of this invention defined in the following claims.

We claim:

1. A method for dynamically determining events, comprising:
concurrently monitoring content tagged with geographic locations located within a plurality of predetermined geofences, each geofence comprising a set of linear boundaries forming a closed loop encircling a geographic region;
selecting a geofence from the plurality of geofences in response to a content generation parameter for content associated with the geofence exceeding a threshold parameter value;
aggregating content associated with the geofence into a content feed; and
sending the content feed to a first user device.

2. The method of claim 1, wherein each geofence is associated with a different threshold parameter value;

3. The method of claim 1, wherein the content generation parameter associated with the geofence comprises a generation frequency of content associated with the geofence, and the threshold parameter value comprises a threshold frequency value.

4. The method of claim 3, wherein the threshold frequency value is determined based on a size of the respective geographic region.

5. The method of claim 1, wherein the content generation parameter associated with the geofence comprises a density of generated content that is associated with locations within the geofence.

6. The method of claim 1, further comprising:
receiving a content exclusion input from the first user device;
determining a geographic location associated with the excluded content; and
adjusting the respective set of line boundaries for the selected geofence to exclude the geographic location.

7. The method of claim 6, wherein adjusting the respective set of line boundaries for the selected geofence to exclude the geographic location comprises assigning endpoints of a first and second contiguous line boundary from a first anchor point to a second anchor point, wherein the first and second anchor points are defined based on physical barriers.

8. A method for geographic content curation, comprising:
receiving content generated by a plurality of users from a plurality of social networking systems;
identifying an event based on analysis of the content;
selecting a first geofence for the event from a set of predetermined geofences based on geographic locations associated with the content, wherein each geofence is bounded by a set of line segments forming a closed loop;
aggregating content tagged with a geographic location located within the first geofence into a content feed; and
publishing the content feed to a first and second user device.

9. The method of claim 8, further comprising:
receiving a content filtering input from the first user device;
selecting a second geofence based on the content filtering input, wherein:
in response to the content filtering input comprising a content inclusion input, the second geofence encompasses a geographic location associated with the included content; and
in response to the content filtering input comprising a content exclusion input, the second geofence excludes a geographic location associated with the included content.

10. The method of claim 9, further comprising:
publishing content associated with locations encompassed by the second geofence to the first user device at a first time; and
publishing content associated with the locations encompassed by the second geofence to the second user device at a second time later than the first time.

11. The method of claim 9, wherein adjacent line segments of each geofence connect at an anchor point associated with a geographic location, wherein selecting a second geofence comprises connecting a first and second adjacent line segment of the first geofence to a new anchor point.

12. The method of claim 8, further comprising aggregating content tagged with an abstracted geotag referencing a geographic region into the content feeds associated with geofences encompassing geographic locations located within the geographic region.

13. The method of claim 8, wherein the content consists of non-calendar events.

14. The method of claim 8, wherein identifying an event based on analysis of the content comprises identifying an event in response to a generation frequency of content associated with geographic locations within the first geofence exceeding a threshold frequency.

15. The method of claim 14, wherein the event comprises a spontaneous event comprising a combination of event parameters that were not user specified prior to event detection.

16. The method of claim 8, wherein the set of predetermined geofences comprises a set of geofences encompassing overlapping geographic areas.

17. The method of claim 16, wherein the set of predetermined geofences comprises a set of nested geofences.

18. The method of claim 8, further comprising:
defining a set of anchor points based on physical barriers; and
defining the set of geofences, comprising connecting the set of line segments to a set of anchor points to define each geofence boundary.

19. The method of claim 18, wherein each geofence is defined in response to receipt of an anchor point user selection.
